(19) United States
(12) Patent Application Publication
(10) Pub. No.: US 2009/0128315 A1
(43) Pub. Date: May 21, 2009

(54) METHOD FOR DETERMINING ABSOLUTE TIRE ROLLING CIRCUMFERENCES AND TIRE PRESSURE CONTROL SYSTEM

(75) Inventors: Martin Griesser, Eschborn (DE); Andreas Kobe, Bensheim (DE); Frank Schreiner, Friedrichsdorf (DE); Stefan Luke, Olpe (DE); Markus Irth, Mainz-kastel (DE); Daniel Fischer, Schwalbach (DE); Christian Sussmann, Oberursel (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/158,493

(22) PCT Filed: Dec. 11, 2006
(86) PCT No.: PCT/EP2006/069544

§ 371 Date: Jan. 7, 2009

(30) Foreign Application Priority Data
Dec. 23, 2005 (DE) 10 2005 062 367.0
Nov. 27, 2006 (DE) 10 2006 055 847.2

(51) Int. Cl. B60C 23/00

(52) U.S. Cl. 340/443

(57) ABSTRACT

A method of determining absolute rolling circumferences of tires of a motor vehicle is disclosed, in which the absolute rolling circumferences (Uᵢ) of the tires are determined by evaluating wheel rotational speed signals (ωᵢ) and signals (dⱼ) of at least one distance sensor, as well as a tire pressure check system.

This application is the U.S. national phase application of PCT International Application No. PCT/EP2006/069544, filed Dec. 11, 2006, which claims priority to German Patent Application No. DE 10 2005 062 367.0, filed Dec. 23, 2005, and German Application No. DE 10 2006 055 847.2, filed Nov. 27, 2006, the contents of such applications being incorporated by reference herein.

### BACKGROUND OF THE INVENTION

1. Field of the Invention

The present invention relates to a method of determining absolute rolling circumferences of tires of a motor vehicle, as well as to a tire pressure check system for the detection of pressure loss at one or more tires of a vehicle.

2. Description of the Related Art

So-called tire pressure monitoring systems with direct pressure measurement are known, as described in application DE 199 26 616 C2, which determine the respective pressure in the associated wheel by means of pressure sensors in the individual tires. Further, so-called indirectly measuring tire pressure monitoring systems (DDS: Deflation Detection System) are known, e.g., from DE 100 58 140 A1, which can detect pressure loss based on auxiliary quantities, e.g., by comparing the rolling circumferences of the individual wheels.

EP 0 578 826 B1 discloses a tire pressure determining device, which determines pressure loss in a tire on the basis of tire oscillations.

WO 01/87647 A1 describes a method and a device for monitoring the tire pressure, which combine a tire pressure monitoring system that is based on the detection of wheel radii and a tire pressure monitoring system that is based on the evaluation of oscillation properties.

A method of determining the absolute rolling circumferences of the tires of a motor vehicle based on wheel rotational speed information is disclosed in DE 10 2005 014 099 A1. In this case, the difference in time between the appearance of corresponding vibrations in the wheel rotational speed signals on front wheel and rear wheel of the same vehicle side is used in order to determine an absolute vehicle speed and the absolute rolling circumferences of the four wheels.

An object of the invention is to provide an alternative method for determining the absolute tire rolling circumferences of a motor vehicle as well as an improved tire pressure monitoring system.

### SUMMARY OF THE INVENTION

According to aspects of the invention, this object is achieved by a method of determining absolute rolling circumferences of tires of a motor vehicle described herein, as well as to a tire pressure check system for the detection of pressure loss at one or more tires of a vehicle described herein.

An idea of evaluating wheel rotational speed information and signals of a distance sensor system in order to determine absolute tire rolling circumferences and to perform improved tire pressure monitoring, respectively, is described herein. The determined tire rolling circumferences can be used to improve the control algorithms and/or the warning indication in electronic systems such as anti-lock system, electronic stability program, traction control system, active chassis system, active rollover protection, electronic brake force distribution or tire pressure monitoring.

According to aspects of the invention, the term ‘number of wheel rotations’ implies not only integral, i.e. ‘full’, wheel rotations but, e.g., also half or quarters of wheel rotations or other fractions of wheel rotations (e.g., 0.27 wheel rotations) or also fractional numbers of wheel rotations (e.g., 3.46 wheel rotations).

It is preferred to use the wheel rotational speed information of an ABS sensor system. When the vehicle is equipped with an indirectly measuring tire pressure monitoring system in which pressure loss is inferred from the rotational behavior of the wheels, or with a combined tire pressure monitoring system comprising an indirectly and a directly measuring tire pressure monitoring system, the wheel rotational speed signals prevail already in the control unit of the tire pressure monitoring system. In this case, the tire rolling circumferences are preferably determined in this control unit.

It is likewise preferred to use the signals of the distance sensors of a system for parking steering aid, for collision avoidance, of a vehicle safety system or a driver assistance system. In a particularly preferred fashion, at least one ultrasonic sensor, one infrared sensor or a radar device is employed in systems of this type. With quite particular preference, distance sensors are used which are directed to the rear and/or to the front and/or laterally with respect to the vehicle.

According to a preferred embodiment of the method of the invention, the absolute rolling circumferences are determined from a distance traveled, which is determined based on the distances found using the distance sensor or the distance sensors, and from the number of the wheel rotations performed by each wheel, which is determined from the wheel rotational speed signals of the wheel. One advantage of this determining method is the quick and direct linking of distance covered and associated wheel rotations. It is especially preferred that the rolling circumferences are this way determined several times and that the determined rolling circumferences are averaged.

Preferably, the distances are determined during driving, e.g., on the super highway or the state road, by using at least one stationary object as a reference point. The reference point is especially preferred to be a bridge or a traffic sign.

It is likewise preferred that the rolling circumferences are determined or learnt as a function of the vehicle speed.

According to another preferred embodiment of the method of the invention, the absolute rolling circumferences are determined as parameters of a calculation model for calculating the path of the vehicle by comparing calculated distances and distances defined by means of the distance sensor(s). In this case, the rolling circumferences are learnt in iteratively over several comparison cycles in a particularly preferred manner. One advantage of this determination method lies in that the calculation model which is, e.g., used in a steering aid for parking maneuvers, and the defined rolling circumferences which are, e.g., used in monitoring the tire pressure, are simultaneously improved.

Favorably, the absolute rolling circumferences are determined or learnt during the method of the invention over a period of time which lasts for one or more travels. This fact allows achieving a sufficient rate of statistical significance and, hence, reliable results. It is especially favorable to determine or learn the rolling circumferences over a predefined period of time or to determine or learn the rolling circumferences until the scattering or variation of the values is below a predetermined threshold.

The absolute rolling circumferences are preferred to be determined or learnt also during one or more special driving maneuvers.

According to an improvement of the method of the invention, the absolute rolling circumferences are determined or learnt during one or more, with particular preference numerous, parking maneuvers and/or ranging maneuvers of the vehicle. In this respect, the rolling circumferences can be determined as parameters of a calculation model for calculating the parking and/or maneuvering path or directly by combining the travel covered and the wheel rotations performed.

It is preferred that the absolute rolling circumferences in the method of the invention are determined or learnt during a straight travel movement of the vehicle in forward or rearward directions. This is advantageous in that the distances or travels measured by the distance sensors along an air line correspond to the travel actually covered. It is likewise preferred that in the determination of the absolute rolling circumferences, as parameters of a calculation model, straight travel movements of the vehicle in forward or rearward directions are taken into consideration or weighted to a more pronounced degree than driving movements with a steering angle unequal to roughly zero degree. As a result, fewer model errors occur in the calculation for the estimated (calculated) path curve.

According to another preferred embodiment of the method of the invention, the absolute rolling circumferences are determined or learnt when this is initiated by the driver or when a change in the tires or wheels is detected. It is particularly preferred that the initiation of the determination of the rolling circumferences is triggered by the driver by actuating a reset key. With quite particular preference, the reset key is the reset key which also initiates the learning operation of an indirect tire pressure monitoring system.

In another embodiment, the information or signals of an indirect tire pressure monitoring system are used to secure the determination of the absolute rolling circumferences. To this end, the absolute rolling circumferences are only determined in periods of time for which no suspicion of tire pressure loss or a constant suspicion thereof is indicated by the indirect tire pressure monitoring system.

In a preferred improvement of the method of the invention, the division error of an encoder of a wheel rotational speed sensor is determined and taken into account for correcting the wheel rotational speed signal. This achieves an enhanced accuracy of the determined rolling circumferences.

The absolute rolling circumferences determined using the method of the invention are preferably sent to at least one electronic vehicle system. Herein, they can be used for improving the control algorithms and/or the warning.

An advantage of the method of the invention involves that a determination of the absolute rolling circumferences of the tires is performed by only evaluating the wheel rotational speed signals of the wheels, which are usually determined already within the limits of an anti-lock system and are thus available, and the signals of distance sensors which are provided in a system for steering aid in parking maneuvers. This renders it possible to realize the method of the invention at low cost. The items of information about the absolute rolling circumferences can then be sent to one or more electronic systems, e.g., an indirectly or directly measuring tire pressure monitoring system or an electronic brake system. Hence, the method of the invention offers the advantage of improving various systems with little effort and cost.

The invention also relates to the implementation of the method of the invention in an indirectly and/or directly measuring tire pressure check system, a system for determining tire properties and/or for determining the type of tires, or an electronic brake system. When the method of the invention is used in an indirectly and/or directly measuring tire pressure check system, the determined absolute rolling circumferences are employed to improve the detection of tire pressure loss. It is especially preferred to employ the method of the invention in an anti-lock system, a traction slip control system or an electronic stability program for improving the brake pressure control.

According to a preferred embodiment of the tire pressure check system according to aspects of the invention, said system comprises a unit in which absolute tire rolling circumferences are established based on the wheel rotational speed signals and the distances determined by the distance sensor(s).

Furthermore, it is preferred that a method according to aspects of the invention is implemented in the tire pressure check system according to aspects of the invention.

These and other aspects of the invention are illustrated in detail by way of the embodiments and are described with respect to the embodiments in the following, making reference to the Figures.

### BRIEF DESCRIPTION OF THE DRAWINGS

In the accompanying drawing:

FIG. 1 is a schematic representation of an embodiment of a method according to aspects of the invention.

### DETAILED DESCRIPTION OF THE PREFERRED EMBODIMENTS

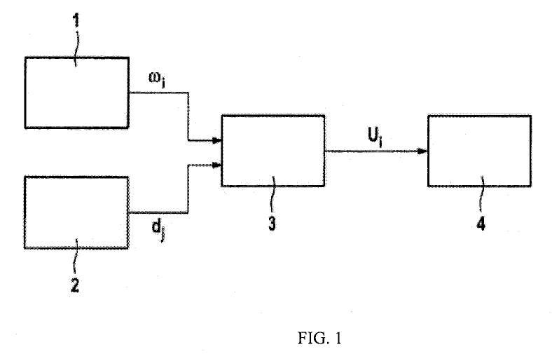

FIG. 1 is a schematic representation of an embodiment of a method of the invention as a flow chart. In block 1, the rotational wheel speeds ωᵢ (the index i relates to the different wheels, e.g., i=1 (right front), 2 (left front), 3 (right rear) and 4 (left rear) in a four-wheel vehicle) of the wheels or quantities which directly relate to these such as rotation times of the wheels or the number of wheel rotations are detected. The wheel rotational speed sensors of an anti-lock system are used, for example, to this end. Distance sensors, e.g., of a motor vehicle device for assisting a driver in the parking maneuver or of a collision avoidance system, are used to measure distances dⱼ, e.g., between the place of attachment of a distance sensor and an object/obstacle, in block 2. The determined wheel rotational speeds ωᵢ and distances dⱼ are related to each other and evaluated in block 3, and absolute rolling circumferences Uᵢ of the tires are determined therefrom. The absolute rolling circumferences Uᵢ are then made available to an electronic vehicle system 4, e.g., an indirectly or directly measuring tire pressure monitoring system or an electronic brake system.

The combined evaluation 3 of the above-mentioned signals Co and dⱼ allows inferring the absolute tire rolling circumference Uᵢ of each one tire. Wheel rotational speeds ωᵢ and distances dⱼ are linked, e.g., in parking maneuvers and/or when maneuvering inside a parking gap until the final parking position. For this purpose, the distance covered is found out by way of the distance sensors by differentiating distances dⱼ and is related to the wheel rotations performed in this action resulting from the wheel rotational speeds ωᵢ. This action allows determining absolute rolling circumferences Uᵢ.

According to a first embodiment, the distances are detected during ‘normal’ driving, e.g., on a superhighway or state road and, preferably, on straight road sections. To this end, a stationary object, e.g., a bridge or a traffic sign, is used as a reference point. A correlation between the travel covered and the number of wheel rotations can be achieved by bearing the reference point and measuring the distance from the reference point. The dependence on the vehicle speed must be taken into consideration due to the size of the tires growing with speed. The absolute rolling circumferences Uᵢ of the tires are therefore determined or learnt as a function of the vehicle speed.

In a second embodiment, a rearwards directed distance sensor is used to measure the distance covered when driving straight backwards in a parking gap, e.g., as a change of the distance dⱼ from a vehicle parking behind. The distance is then related to the wheel rotations measured by means of the wheel rotational speed sensors, and the absolute rolling circumference Uᵢ of the tires is determined this way.

According to another embodiment, the length of a parking gap is measured when driving past the gap by laterally directed distance sensors or by standing in the parking gap by distance sensors directed to the front and the rear. The absolute rolling circumferences Uᵢ of the tires are then determined based on the information about the length of the parking gap and the wheel rotational speeds ωⱼ determined when passing by.

In another embodiment, the absolute rolling circumferences Uᵢ are defined as model parameters in a method for steering into a parking gap. Such methods, which allow a parallel parking maneuver in a fully automatic or semi-automatic fashion, usually execute this process in the subsequent steps:
measuring the parking gap when driving past (e.g., by means of laterally directed distance sensors),
indicating whether the parking gap is sufficient in size and whether the vehicle is within a valid starting range for the parking maneuver,
calculating a path for entering into the parking gap,
traveling on the path while simultaneously correcting the path, and
maneuvering within the parking gap.

According to aspects of the invention, a learning algorithm is implemented in a like method comparing the difference, after having entered the parking gap, between a distance which is predicted by a model calculating on the basis of wheel rotational speed information, and the distance dⱼ from the rear parking gap boundary which is measured, e.g., by means of distance sensors directed to the rear. For the first prediction, standard values for the rolling circumferences Uᵢ of the tires are used, and a standard path curve depending on the steering angle is employed. It is possible by comparing the predicted distance and the distance dⱼ measured by means of distance sensors to detect the current model error and to diminish it continuously by the learning algorithm. The model parameters which have to be optimized continuously in this process are the tire rolling circumferences Uᵢ and a parameter describing the correlation between steering angle and vehicle path curve.

The improved model parameters found, i.e. the improved rolling circumferences Uᵢ of the tires, or the model deviation, are stored and used again as start values for the next parking maneuver and/or in the next ignition cycle. Depending on this deviation and the confidence in the value of the distance sensors directed to the rear, the beginning of the parking gap can be displaced correspondingly in the next parking maneuver, or the safety distances considered within the limits of the model can be decreased or increased.

In another embodiment, the distance sensors directed to the front and to the rear are used to measure the length of the parking gap when maneuvering within the parking gap and in the final parking position. The deviation between the length of the parking gap which is predicted according to the calculation model with assumed rolling circumferences Uᵢ and the measured parking gap length can be memorized. With a factor indicating the reliability of the measured distance values, it is possible to adapt the tire rolling circumferences Uᵢ in order to be able to provide a more accurate prediction during the next parking maneuver and, hence, to enter into the parking gap with higher precision.

Preferably, the wheel rotational speeds ωᵢ and the distances dⱼ are combined in driving situations with a steering angle of roughly zero degree, i.e. with an approximate straight travel. It is thereby ensured that the ‘air line’ measured by the distance sensors corresponds to the distance traveled.

In a determination of the tire rolling circumferences Uᵢ by way of a parameter model, driving situations with a steering angle of roughly zero degree, i.e. approximate straight travel, are taken into consideration or weighted in a special way because it is not necessary to consider steering-angle-responsive model errors for the estimated (calculated) path curve in this case.

A sufficient rate of precision of the distance sensors used, in particular those directed to the front and the rear, is required in order to determine the tire rolling circumferences Uᵢ as accurately as possible.

It is likewise favorable for improving the achieved precision when the division error of each encoder of the wheel rotational speed sensors is learnt during driving. The learnt division errors are then respectively used for correcting the wheel rotational speeds ωᵢ. A correction is relevant in particular when evaluating fractions of wheel rotations. Furthermore, it is advantageous to determine the tire rolling circumferences Uᵢ by long-term monitoring operations, for example, during a large number of parking and/or ranging maneuvers.

In another embodiment of the method of the invention or the tire pressure monitoring system, there is a reset possibility, e.g., in the form of a key or a menu item in the on-board computer, in order to indicate changes at the tires to the system. After the reset, the tire rolling circumferences Uᵢ are newly determined or learnt.

The tire pressure monitoring system of the invention or the method of the invention are preferably combined or employed as follows:
a. Combination with the prior art indirect tire pressure check systems which evaluate, e.g., relative changes in the rolling circumferences and changed oscillation properties of the tires.
   Most important advantages:
   enhanced robustness by plausibilisation of the signals, and
   increased availability of the overall system since different conditions of use/conditions of availability of the single systems are given.
b. The determined absolute tire rolling circumferences Uᵢ can also be taken into consideration for the identification of the type of tire.
   Advantages:
   thresholds for the warning of lack in pressure of an indirect tire pressure check system can be adapted tire-responsively, and/or
   identification of greatly differing tires.
c. Combination with a directly measuring tire pressure monitoring system or other sensor-based methods and devices, such as methods or devices detecting the tire identity.

1.-18. (canceled)

19. Method of determining absolute rolling circumferences of tires of a motor vehicle, wherein the absolute rolling circumferences (Uᵢ) of the tires are determined by evaluating wheel rotational speed signals (ωᵢ) and signals (dⱼ) of at least one distance sensor.

20. Method as claimed in claim 19,
wherein the at least one distance sensor is used:
(a) in a device or a method for assisting a driver in parking or maneuvering of a motor vehicle;
(b) in a collision avoidance system;
(c) in a vehicle safety system;
(d) in a driver assistance system;
(e) or any combination thereof.

21. Method as claimed in claim 19,
wherein the absolute rolling circumferences (Uᵢ) are determined from a distance traveled, which is determined from the signals (dⱼ) of the at least one distance sensor, and from a number of wheel rotations performed by each wheel during the distance traveled, which is determined from the wheel rotational speed signals (ωᵢ) of each wheel.

22. Method as claimed in claim 19,
wherein the absolute rolling circumferences (Uᵢ) are determined iteratively as parameters of a calculation model for calculating a path of the vehicle by comparing calculated distances and distances defined by means of the at least one distance sensor.

23. Method as claimed in claim 19,
wherein the absolute rolling circumferences (Uᵢ) are determined over a period of time lasting one or more travels.

24. Method as claimed in claim 19,
wherein the absolute rolling circumferences (Uᵢ) are determined during one or more special driving maneuvers.

25. Method as claimed in claim 19,
wherein the absolute rolling circumferences (Uᵢ) are determined during one or more parking maneuvers, one or more ranging maneuvers of the vehicle, or any combination thereof.

26. Method as claimed in claim 19,
wherein the absolute rolling circumferences (Uᵢ) are determined during a straight travel movement of the vehicle in a forward or a rearward direction.

27. Method as claimed in claim 19,
wherein the absolute rolling circumferences (Uᵢ) are determined as parameters of a calculation model, wherein the calculation model accounts for straight travel movements of the vehicle in a forward or a rearward direction to a more pronounced degree than driving movements with a steering angle that is unequal to approximately zero degrees.

28. Method as claimed in claim 19,
wherein the absolute rolling circumferences (Uᵢ) are determined upon initiation by a driver of the vehicle.

29. Method as claimed in claim 28,
wherein initiation by a driver of the vehicle occurs upon actuation of a reset key, or detection of a change at the tires or wheels.

30. Method as claimed in claim 19,
wherein the absolute rolling circumferences (Uᵢ) are determined only when a tire pressure monitoring system provided in the vehicle does not indicate a tire pressure loss.

31. Method as claimed in claim 19,
wherein a division error of an encoder of a wheel rotational speed sensor is determined and considered for a correction of the wheel rotational speed signal (ωᵢ).

32. Method as claimed in claim 19,
wherein the absolute rolling circumferences (Uᵢ) are transmitted to at least one electronic vehicle system.

33. Implementation of the method as claimed in claim 19
(a) in an indirectly measuring tire pressure check system, a directly measuring tire pressure check system, or combination thereof;
(b) in a system for determining tire properties; or
(c) in an electronic brake system selected from the group consisting of an anti-lock system, a traction slip control system and an electronic stability program.

34. A tire pressure check system for the detection of pressure loss at one or more tires of a vehicle,
wherein said system comprises a unit configured to detect a pressure loss of at least one tire based on wheel rotational speed signals (ωᵢ) and signals (dⱼ) of at least one distance sensor.

35. Tire pressure check system as claimed in claim 34,
wherein said system comprises a unit in which absolute tire rolling circumferences (Uᵢ) are determined from wheel rotational speed signals (ωᵢ) and the signals (dⱼ) of the at least one distance sensor.

36. Tire pressure check system as claimed in claim 34,
wherein the at least one distance sensors employed is part of a device for:
(a) assisting a driver in parking or maneuvering of a motor vehicle;
(b) a collision avoidance system;
(c) a vehicle safety system; or
(d) a driver assistance system.

37. Tire pressure check system as claimed in claim 34,
wherein the distance sensor employed is directed to the front of the vehicle, to the rear of the vehicle, laterally in relation to the vehicle, or any combination thereof.

38. A system for the detection of pressure loss and the determination of absolute rolling circumferences of one or more tires of a vehicle, said system comprising a unit configured to detect a pressure loss of at least one tire and the absolute rolling circumferences of one or more tires of a vehicle based on wheel rotational speed signals (ωᵢ) and signals (dⱼ) of the at least one distance sensor.
